(19) United States
(12) Patent Application Publication
(10) Pub. No.: US 2009/0206970 A1
(43) Pub. Date: Aug. 20, 2009

(54) DEVICE FOR COUPLING AN ATTACHMENT

(75) Inventors: Hansjörg Cueni, Stansstad (CH); Heiner Scherrer, Büsserach (CH)

Correspondence Address: LADAS & PARRY LLP, 224 SOUTH MICHIGAN AVENUE, SUITE 1600, CHICAGO, IL, 60604, US

(73) Assignee: CTC ANALYTICS AG, Zwingen (CH)

(21) Appl. No.: 11/718,744

(22) PCT Filed: Nov. 7, 2005
(86) PCT No.: PCT/CH05/00653

§ 371 Date: Apr. 10, 2008

(30) Foreign Application Priority Data
Nov. 8, 2004 (CH) 1834/04

(51) Int. Cl. H01F 7/02

(52) U.S. Cl. 335/286

(57) ABSTRACT

A coupling ring (13), which on its underside has a plurality of permanent magnets (16) that are preferably disposed concentrically and with angular offset, and which is disposed laterally on that part of the transport device which is moved in the Z direction, serves to temporarily couple an instrument (10) or tool onto a transport mechanism. The coupling ring cooperates with a coupling plate (17), which is disposed on the upper side of the respective instrument to be coupled-on, and which has permanent magnets (19) of correspondingly opposite polarity disposed with the same distribution.

The invention relates to an apparatus for temporarily coupling-on an instrument or a tool to a transport mechanism such as, for example, an XYZ robot of an analysis device.

The devices typically present in analysis equipment for performing series of analyses include a transport device, by means of which pipettes, syringes, measuring probes, etc., which, for the purpose of this description, are combined under the term “instruments”, are guided to a multiplicity of positions. These positions are located, for example, at a multiplicity of cuvettes, for the purpose of extracting or introducing samples, measuring a reaction that has taken place, and the like. In such cases, the containers or cuvettes are usually disposed in an XY matrix. The instruments are usually located in a head which is moved in the Z direction. Such transport devices are frequently termed XYZ robots.

As the requirements and possibilities of chemical analysis increase, there is also an increasing need for greater flexibility in respect of the instruments present in the Z head, and in respect of their functions. This can be achieved to a certain extent, by having a plurality of instruments disposed in the head and with the instruments being used as required. This solution does not achieve adequate flexibility, however, despite a large resource input.

It has also already been proposed that exchangeable instruments be coupled onto the head as required. Hitherto, however, this has not proved satisfactory, on account of the elaborate coupling mechanisms.

Consequently, there is still a need for a solution that gives a very high degree of flexibility with simple means. This is the object on which the present invention is based.

According to the invention, this is achieved by a coupling ring, which on its underside has a plurality of permanent magnets that are preferably disposed concentrically and with angular offset, and which is disposed laterally on that part of the transport device which is moved in the Z direction, a coupling plate, which is disposed on the upper side of the respective instrument to be coupled-on and which has permanent magnets of correspondingly opposite polarity disposed with the same distribution as on the coupling ring, and a stationary holder for holding the instrument when not in use.

A preferred exemplary embodiment of the invention is described in the following with reference to the accompanying drawings, wherein:

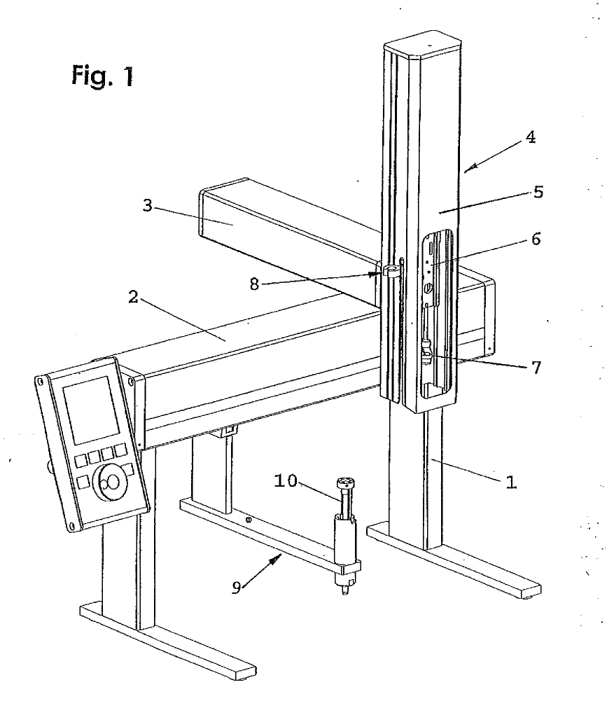

FIG. 1 shows a perspective representation of an XYZ robot

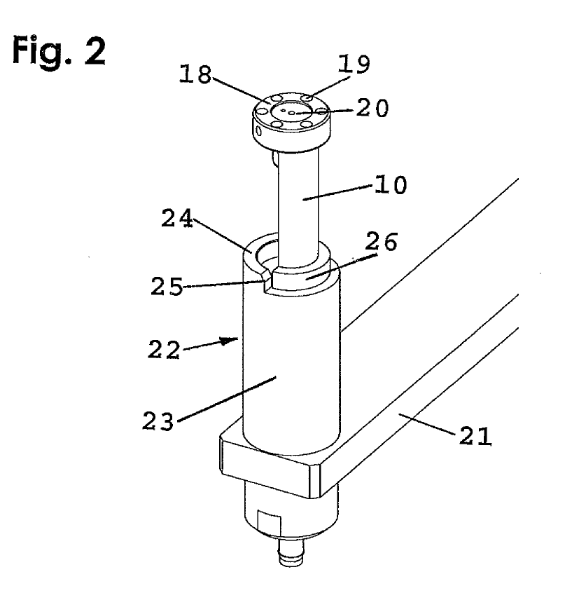

FIG. 2 shows an enlarged representation of a holder for an additional instrument

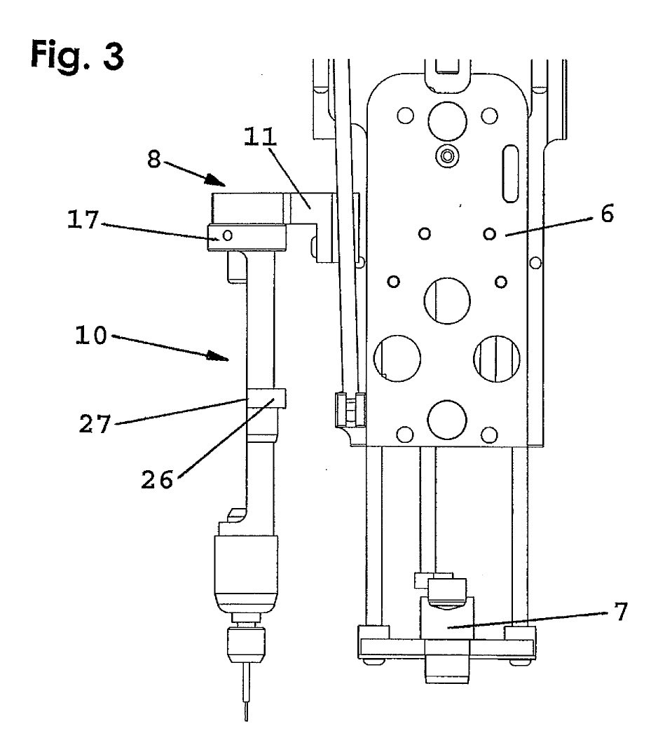

FIG. 3 shows a front view of the Z head without housing

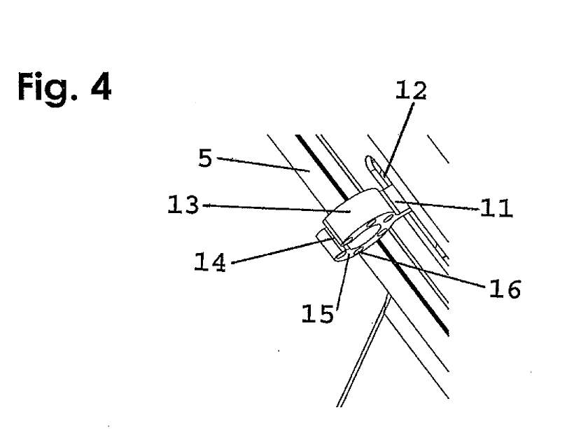

FIG. 4 shows an enlarged bottom view of the coupling ring disposed on the Z head.

The XYZ robot shown in perspective representation in FIG. 1 corresponds largely to a commercially available product, and consists of a bridge 2, which is provided with a supporting pillar 1, and of a cantilever arm 3 and a head 4. The bridge defines the X axis of the robot. By means of drive mechanisms known per se, the cantilever arm 3 travels to and fro in the X direction, and also back and forth in the Y direction. The head 4 disposed on the end face of the cantilever arm 3 has, within a housing 5, a carriage 6 which travels up and down vertically, i.e. in the Z direction, and at the lower end of which, in the case of the present example, there is disposed a sample delivery device 7 for the test procedure known as MALDI spotting.

Alternatively, the head may obviously be provided, in known manner and depending on the application, with a pipette, a syringe, an optical sensor, an agitator, etc., i.e. with instruments of a great variety of functions.

Unlike the known product, the present XYZ robot has a coupling apparatus 8 and a holder 9 for an additional instrument 10. The coupling apparatus 8 and the holder 9 for an additional instrument 10 are shown in enlarged form in FIGS. 2-4. The coupling apparatus consists of an arm 11, one end of which is fixed to the carriage 6, and which extends outwards through a slot 12 in the housing 5. Realized outside of the housing, at the other end of the arm 11, is a partially open coupling ring 13, which has an opening 14 at its front end. Six permanent magnets 16 are disposed at equal angular distances on the underside 15 of the coupling ring. These are cylindrical magnets, which are inserted in corresponding recesses and whose end faces are flush with the underside of the coupling ring. The magnets are inserted in such a way that they are of alternate polarity on the underside of the coupling ring.

In the present case, the additional instrument 10 is a device for depositing single drops of a reagent onto a MALDI plate. Alternatively, depending on the application, the additional instrument may be a pipette, a syringe, a probe, etc., or even a mechanical tool. Irrespective of its design and its function, at its upper end the instrument has a coupling plate 17, in the surface 18 of which there are disposed six permanent magnets 19. As in the case of the coupling ring 13, the magnets are cylindrical magnets, which are inserted in corresponding recesses so as to be flush with the surface 18, and likewise they are of alternate polarity. The coupling plate may be provided with a central bore 20, for leading through a feed line or the like, and then likewise is in the form of a ring.

The number of six magnets, in the case of the described device, is only one of a plurality of possibilities. It is also possible to provide fewer magnets or more magnets, which may also have the same polarity. If alternate polarity is provided in order to achieve self-centering, however, an even number of magnets is advantageous.

The arrangement of the magnets is selected in such a way that, when the instrument is in the desired position, in each case there is attraction between the magnets of the coupling ring and those of the coupling plate. Any deviation of the angular position or of the lateral position of the instrument relative to the head would result in a reduction of the attraction of oppositely disposed magnets and in an increase in the repulsion between adjacent magnets, such that a self-centering effect is thereby produced. The precision of this self-centering is in the order of magnitude of 0.1 mm.

As can be seen from the enlarged representation in FIG. 2, the holder 9 consists of a substantially L-shaped carrier 21, which is disposed on the underside of the bridge, and of a receptacle 22, which is disposed on said carrier and in which the instrument 10 is parked when not in use. The receptacle consists of a tube 23, the upper edge 24 of which is provided with a shoulder 25. At the level corresponding to the edge 24, the instrument 10 has a partially circumferential flange 26, the end faces of which constitute stop faces 27 that bear against the shoulder 25 when the instrument is in the receptacle. The shoulder 25 and the stop 26 serve to define the precise angular position of the instrument when it is not in use.

The coupling-on and coupling-off of the instrument are controlled by the robot's software, which is supplemented appropriately for this purpose. For the purpose of coupling-on, the head travels to the instrument in such a way that the coupling ring is located coaxially over the coupling plate. In this XY position, the carriage is lowered with the coupling ring. As soon as the coupling ring comes close to the coupling plate, the instrument is raised by the magnetic attraction and held in a precise position by the self-centering. The additional functions, as provided for with use of the instrument, can now be performed. For this purpose, the XYZ control takes account of the difference of the coordinates between the sample delivery and the pipette tip.

When the instrument is no longer required, it is decoupled. For this purpose, the head travels to the receptacle in such a way that the instrument is located coaxially over the latter. Through lowering of the carriage, the instrument is brought fully into its parked position, in which its angular position is defined. The head thereupon travels away sideways, i.e. in the X direction, in order to separate the coupling ring from the coupling plate.

If a plurality of different instruments are to be used for a series of tests, a plurality of receptacles may be disposed adjacently to one another on the holder, from which receptacles the respectively required instrument is coupled onto the head as required, and to which receptacles it is returned after use.

In addition to the application described, a coupling of this type is suitable for a multiplicity of applications in which positional precision, but only a small mechanical connection force, is required, and in which the coupling-on and decoupling operations are to be very easy.

1. An apparatus for temporarily coupling an instrument or tool onto a transport mechanism, characterized by a coupling ring (13), which on its underside (15) has a plurality of permanent magnets (16) and is disposed laterally on a part (4) of the transport device, said part being moved in the Z direction, a coupling plate (17), which is disposed on the upper side of the respective instrument (10) to be coupled-on and which has permanent magnets (19) of correspondingly opposite polarity disposed with the same distribution as on the coupling ring, and a stationary holder (9) for holding the instrument when not in use.

2. The apparatus as claimed in claim 1, characterized in that the permanent magnets on the underside of the coupling ring and on the coupling plate are disposed concentrically and with angular offset.

3. The apparatus as claimed in claim 2, characterized in that the permanent magnets are of alternate polarity.

4. The apparatus as claimed in claim 1, characterized in that the holder has a receptacle for parking the instrument when not in use.

5. The apparatus as claimed in claim 4, characterized in that the receptacle has an upper edge with means for the defined positioning of the instrument.

6. The apparatus as claimed in claim 5, characterized in that the means for positioning consist of a shoulder on the upper edge of the receptacle and of a partially circumferential flange on the instrument.
